(19) United States
(12) Patent Application Publication
(10) Pub. No.: US 2016/0031713 A1
(43) Pub. Date: Feb. 4, 2016

(54) ACTIVATED CARBON WITH HIGH PERCENTAGE MESOPOROSITY, SURFACE AREA, AND TOTAL PORE VOLUME

(71) Applicant: Washington State University, Pullman, WA (US)

(72) Inventors: David Elliot Fish, Bellevue, WA (US); Stephen Carter Fox, Idaho Falls, ID (US); James Ian Dallmeyer, Pullman, WA (US)

(21) Appl. No.: 14/816,260

(22) Filed: Aug. 3, 2015

Related U.S. Application Data
(60) Provisional application No. 62/032,412, filed on Aug. 1, 2014.

(51) Int. Cl. C01B 31/10; H01G 11/26; H01G 11/34; B01J 20/20; B01J 20/30

(52) U.S. Cl. CPC C01B 31/10; B01J 20/20; B01J 20/3085; H01G 11/34; H01G 11/26

(57) ABSTRACT

A method of producing high grade activated carbon is introduced. The method entails providing soft wood biomass material pretreated to result in a mass of fermentation residual solids having a desired content of lignin. The material is pyrolyzed/carbonized in an inert environment at a temperature rate of 10° C./min up to an upper temperature range and held at the upper temperature range for up to one hour to produce char. Thereafter, the char is activated by changing the inert environment after about one hour at the upper temperature range to an oxidizing environment at a desired oxidizing gas flow rate for a predetermined time period. The environment is then switched back to an inert environment and allowed to cool until room temperature is reached so as to produce the activated high grade carbon. Applications for the material include but is not limited to: carbon electrodes in supercapacitors and mercury adsorbent material.

### CROSS-REFERENCE TO RELATED APPLICATIONS

The present application claims under 35 U.S.C. §119, the priority benefit of U.S. Provisional Application No. 62/032,412, filed Aug. 1, 2014, entitled: “ACTIVATED CARBON WITH HIGH PRECENTAGE MESOPOROSITY, SURFACE AREA, AND TOTAL PORE VOLUME.” The disclosure of the foregoing application is incorporated herein by reference in its entirety.

### GOVERNMENT INTERESTS

This invention was made with government support under the Agriculture and Food Research Initiative grant number 2011-68005-30416 awarded by the United States Department of Agriculture, National Institute of Food and Agriculture. The government has certain rights in the invention

### BACKGROUND OF THE INVENTION

1. Field of the Invention

The present embodiments herein relate to the field of producing activated carbon, and more particularly, relates to a process for producing mesoporous/microporous activated carbons with higher percentages of mesoporosity, larger apparent specific surface areas, and greater pore volumes.

2. Discussion of the Related Art

Activated carbon (AC) is an important class of industrial products widely used as an adsorbent in applications including, but not limited to water treatment, gas purification, gas separations, and solvent recovery. AC's can also be used in a range of other applications including as media for hydrogen storage, electric charge collectors in supercapacitors, and as catalysts or catalyst supports in chemical synthesis. A comprehensive list of all industrial applications for AC would be prohibitively long.

AC's can be made from a variety of carbonaceous raw materials, including coal, peat, wood, nut shells, and synthetic polymers. The production process for AC depends on both the choice of raw material and the desired final properties. For lignocellulosic precursors such as wood and nut shells, the production process generally includes a carbonization step followed by an activation step. The carbonization step involves heating the raw material to between 500° and 750° C. in the absence of oxygen. The activation step can generally take one of two forms: a “physical” activation in the presence of an oxidizing gas (often steam or CO2) at temperatures between 750° and 1000° C., or a “chemical” activation by impregnating the carbonized material with a chemical (often a mineral acid, alkali metal hydroxide, or zinc chloride) followed by heating to around 500° C. The physical properties, including pore structure, and the yield of the final AC product will depend on a combination of the choice of raw material and the specific production conditions used.

AC's can be made from a variety of carbonaceous raw materials, including coal, peat, wood, nut shells, and synthetic polymers. The production process for AC depends on both the choice of raw material and the desired final properties. For lignocellulosic precursors such as wood and nut shells, the production process generally includes a carbonization step followed by an activation step. The carbonization step involves heating the raw material to between 500° and 750° C. in the absence of oxygen. The activation step can generally take one of two forms: a “physical” activation in the presence of an oxidizing gas (often steam or CO2) at temperatures between 750° and 1000° C., or a “chemical” activation by impregnating the carbonized material with a chemical (often a mineral acid, alkali metal hydroxide, or zinc chloride) followed by heating to around 500° C. The physical properties, including pore structure, and the yield of the final AC product will depend on a combination of the choice of raw material and the specific production conditions used.

The choice of lignocellulosic raw materials for producing AC is known to result in a product with high microporosity. It is desirable, however, to be able to produce AC's from lignocellulosic precursors that contain a higher volume of mesopores in order to access a greater number of applications and markets. Presently, most mesoporous AC's are produced from synthetic phenolic resins using either hard or soft templating techniques. Hard templating is achieved by impregnating the phenolic resin with silica prior to carbonization, followed by leaching out of the silica to create the pores. Soft templating involves the synthesis of block copolymers from the phenolic resins that leads to the formation of immiscible domains, which then creates the desired pore structure during carbonization. Both these templating techniques suffer from drawbacks, including the use of toxic chemicals, expensive synthetic steps, and non-renewable raw materials. Methods have been reported to make mesoporous carbons from renewable lignocellulosic precursors. One method applied the soft templating technique to purified Kraft lignin, a byproduct from the commercial pulping of wood. Another method required chemical activation of peach stones using zinc chloride. Thus, while these methods did successfully demonstrate the use of renewable raw materials, they still require either an expensive synthetic step or the use of toxic chemicals

The invention described herein presents a method to produce AC's from renewable lignocellulosic precursors using only a carbonization step followed by a physical activation step using CO2. The lignocellulosic precursor is the lignin-rich byproduct of the conversion of plant biomass to renewable chemicals and transportation fuels. Thus, AC's with high mesoporosity are produced from a renewable feedstock using simple methods that avoid the need for chemical activation or extra synthetic steps.

### SUMMARY OF THE INVENTION

It is to be appreciated that the present example embodiments herein are directed to a method of producing high grade activated carbon, to include: providing soft wood biomass material; pretreating the soft wood biomass material, wherein the pretreated soft woody biomass material results in a mass of fermentation residual solids having a desired content of lignin; pyrolysing/carbonizing the fermentation residual solids in an inert environment at a temperature rate of 10° C./min up to about 700° C. and held at the upper temperature range for up to one hour to produce a char; activating the char by changing the inert environment after one hour at 700° C. to an oxidizing environment at a desired oxidizing gas flow rate for a time period of about 5 minutes up to about 120 minutes; switching back to an inert environment and allowing the environment to cool until room temperature is reached; and removing the produced activated high grade activated carbon. As an alternative embodiment, the process can be carried out in separate steps whereby the carbonization step is carried out in one reactor under inert conditions for one hour at 700° C. followed by cooling under inert gas and activation in a second reactor under oxidizing conditions at 700° C.

Another aspect of the embodiments herein is directed to an activated carbon composition suitable for use as an adsorbent or electrode, the composition comprised of: a configuration having mesopore volumes in the range of 0.05 up to 0.50 cm³/g, a pore volume fraction (Vₘₑₛₒ/(Vₘₑₛₒ+V_{micro}) ranging from 0.2 up to 0.8, and an apparent specific area ranging from 500 m²/g up to 2500 m²/g, the composite resulting from activation of lignin-rich fermentation residual solids.

### BRIEF DESCRIPTION OF THE DRAWINGS

FIG. 1 shows a general process schematic for making activated carbon (AC).

FIG. 2 shows a plot of breakthrough curves so as to illustrate removal of elemental mercury from coal combustion flue gas. The curves correspond to Sulfite Pretreatment to Overcome Recalcitrance of Lignocellulose (SPORL) fermentation residual solids (FRS)-based AC activated for 30, 60, and 90 minutes. The control curve corresponds to a commercial coal-based AC used for mercury capture.

FIG. 3 shows adsorption isotherms of SPORL FRS AC activated with CO₂ for 30, 60, and 90 minutes to illustrate the effect of activation on the development of porosity in the AC materials disclosed herein.

FIG. 4 shows a plot of the calculated cumulative pore volume as a function of the pore entrance width for ACs activated at 30, 60, and 90 minutes.

FIG. 5 shows differential pore size distributions of the AC materials activated for 30, 60, and 90 minutes.

FIG. 6 shows a plot of the burn-off of chars with increasing activation time under carbon dioxide flow at 700° C. for SPORL FRS and Douglas fir wood powder chars (DFWC), and chars derived from carbonization of SPORL FRS demineralized by washing with 10% HCl (Washed SPORL FRS).

FIG. 7 Nitrogen adsorption isotherms of Douglas Fir wood char (DFW Char) and activated carbons prepared from Douglas Fir wood char (DFW AC90) and demineralized SPORL FRS (Washed FRS AC90).

FIG. 8 shows a plot of the cumulative pore volume vs. pore width for activated carbons prepared from Douglas Fir wood char and demineralized SPORL FRS by activation with CO₂ for 90 minutes at 700° C.

FIG. 9 shows a plot of the differential pore volume vs. pore width for activated carbons prepared from Douglas Fir wood char (DFW AC90) and demineralized SPORL FRS (Washed FRS AC90) by activation with CO₂ for 90 minutes at 700° C.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. It is to be noted that as used herein, the term “adjacent” does not require immediate adjacency. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise.

In addition, unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

### Specific Description

Biomass (e.g., Biomass feedstock), as utilized herein can include softwood, herbaceous plants, or other biomass feedstock. Specific examples of softwood include fir (e.g., Douglas fir, Grand fir, White fir), spruce and pine (e.g., red pine, forest chips of Loblolly pine, Southern pine, Lodgepole pine or Jack Pine). Herbaceous plants include agriculture residue (e.g., wheat straw, rice straw, herbage, corn stover) and energy crops, such as, switchgrass. Other feedstocks, such as, but not limited to, saw dust or waste paper can also be utilized herein without departing from the scope of the invention.

Activation, as disclosed herein, refers to the process of increasing the porosity of carbonized feedstock using either physical activation, chemical activation, or a combination of both. Prior to activation, the biomass material, as briefly described above, is pretreated using a number of desired methods to provide for Fermentation Residual Solids” (FRS), i.e., as lignin rich material that comprises about 50% up to about 70% lignin.

In particular, pretreatment of the soft starting biomass material is often carried out prior to attempting the enzymatic hydrolysis of the cellulose and hemicellulose in the starting biomass material. Pretreatment refers to a process that converts lignocellulosic starting biomass material, as briefly discussed above, from its basic native form, i.e., a form that is recalcitrant to cellulase enzyme systems, into a form for which hydrolysis is effective. The pretreated lignocellulosic materials provided herein are exemplified by an increased surface area (porosity) accessible to cellulase enzymes, and solubilization or redistribution of lignin. In particular, increased porosity results from a combination of disruption of cellulose crystallinity, hemicellulose disruption/solubilization, and lignin redistribution and/or solubilization.

The overall effectiveness in accomplishing at least some of these factors differs greatly among the different pretreatment processes when used in combination with downstream processes that are utilized by the embodiments herein. Such pretreatment methods include, but are not strictly limited to, Wet Ox (which uses only high pressure oxygen and steam), Sulfite Pretreatment to Overcome Recalcitrance of Lignocellulose (SPORL), and Tandem Milling, as known to those of ordinary skill in the art. It is to be reiterated that these particular non-limiting pre-treatment methods in combination with particular carbonization and activation conditions, type of activation, and any other parameters deemed necessary to tailor the materials herein enable the novel large specific surface area, high meso pore volumes/meso-to-micro pore ratio activated carbon substances of the present application

SPORL, in particular when combined with other downstream processes disclosed herein, is desirable because in conversion of the starting biomass material through enzymatic saccharification, the method has been shown to be effective in directly pretreating chip or other size starting material without further size reduction and chip impregnation.

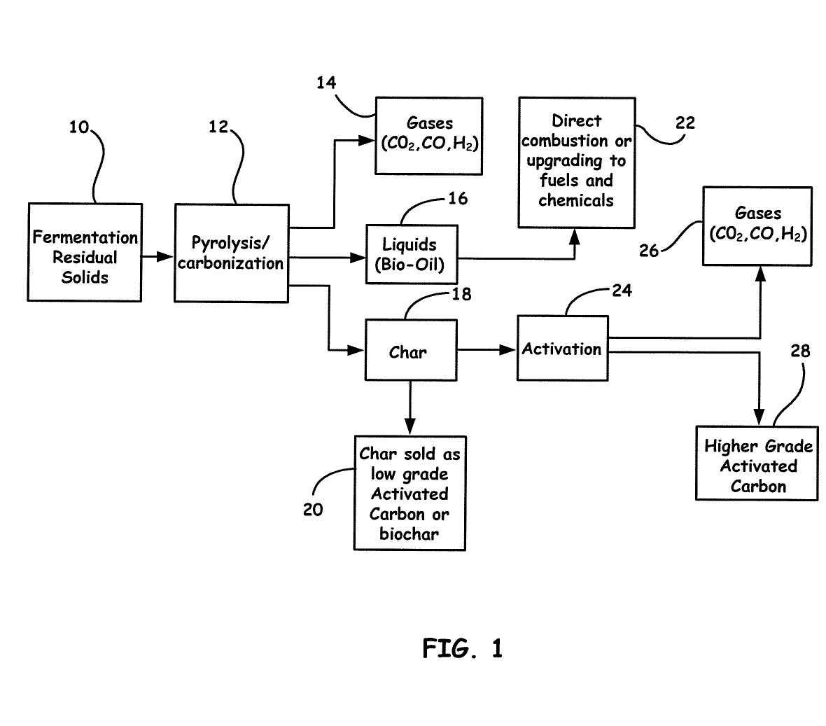

It is to be appreciated that the processes herein can be utilized on lignin-rich solids that are diverted before fermentation, wherein the solids are referred to as saccharification residual solids (SRS). However, often the particular pretreatment method, of which the non-limiting example methods are disclosed above, is more often utilized in a predetermined manner for desired activated carbon properties in combination with a secondary process of the “Fermentation Residual Solids” (FRS). FIG. 1 illustrates such a generic method of operation. Variables of the process shown in FIG. 1 include temperature (carbonization and activation), residence time, heating and cooling rate, feedstock moisture content, atmosphere composition, particle size, type of activation (physical and/or chemical), as well as the kind of pre- or post-treatment.

Turning back to FIG. 1, the received pretreated samples, i.e., fermentation residual solids (FRS) 10, to enable the activated carbon structures herein, are first prepared in a tube furnace, such as, for example, a Thermo Scientific Lindberg Blue M 3-zone using a 2-inch diameter quartz tube. The received FRS 10 samples are often dried overnight in an oven heated to 105° C. to remove residual moisture. The samples are then ground into powders and placed in the tube furnace in quartz boats, and the tube is sealed off from the air at both ends. Reference character 12 depicts the pyrolysis/carbonization step wherein the samples are first held at room temperature under a flow of dry nitrogen gas, such as, but not limited to, a flow rate of 500 mL/min for one hour, to obtain an inert environment for carbonization and then heated under nitrogen at a heating rate of, for example, a rate of 10° C./min up to 700° C. and held at the upper temperature range, e.g., 700° C., for up to one hour under nitrogen flow. Reference characters 14, 16, 22, and 26 depict residual bi-products as part of the overall process. In particular, Bio-oil 16 can be burned for energy or upgraded to a fuel material 22.

In the case of unactivated samples (“chars”) 18, as shown in FIG. 1, the furnace is allowed to cool under nitrogen at an uncontrolled rate until it reaches room temperature, and the samples are then removed from the furnace and weighed to calculate the yield of char as a percentage of the initial dried FRS weight.

To prepare physically activated samples as an example in step 24, the gas flow is changed after one hour at 700° C. from nitrogen to carbon dioxide (flow rate=500 mL/min) (i.e., now an oxidizing atmosphere, e.g., CO₂, steam, or even a combination of CO₂ and steam) and the samples are held under carbon dioxide flow at 700° C. for a time of 5, 15, 30, 60, 90, or up to 120 minutes, referred to as the activation time. After activation, the gas flow is switched back to nitrogen and the samples are allowed to cool at an uncontrolled rate under nitrogen to room temperature.

The higher grade activated carbon 28 samples are then removed from the furnace and weighed to determine the yield of activated carbon as a percentage of initial oven-dried FRS weight. To determine the effect of acid washing on the ash content and porosity of the activated carbon, some samples are washed with aqueous hydrochloric acid (pH 2) followed by washing with water to wash away the acid. These samples are then dried in an oven under air to constant weight at 60° C. followed by further drying to constant weight at 105° C.

A unique and thus novel aspect of the activated carbons disclosed herein, as produced from the non-limiting mild bisulfite fermentation method of providing fermentation residual solids, is that they can be prepared with a relatively high mesopore fraction, whereas physically activated wet oxidation FRS always contain a relatively large fraction of micropores. Such a result is due to a catalytic effect on carbon gasification during the activation process due to inorganic components from the pulping chemicals retained in the FRS from mild bisulfite pretreatment.

It is to be noted in particular that when using the non-limiting bisulfite treatment, such a method herein generates both fermentable sugar and operates as a precursor for mesoporous activated carbon. Moreover, while it is known that that inorganics can catalyze the gasification of carbon during activation and lead to mesoporosity development, it is still a challenge to produce well-defined mesoporosity from lignocellulosics. Thus, in using the beneficial bisulfite pre-treatment, the present process is simplified because the precursor material is merely subjected to a traditional physical activation after the bisulfite biomass pretreatment.

The point to be made is that the mesoporous materials provided by any of the variables using the methods herein are beneficial for applications where rapid diffusion of adsorptive species throughout the bulk of the activated carbon particle is necessary to achieve the desired function. This rapid transport is especially useful in applications, such as, but not limited to mercury adsorption, where there is only a short contact time between the activated carbon particle and the phase from which adsorptive species are removed or adsorbed. Removal of mercury from coal flue gas is thus one example of an application that the present example embodiments addresses, wherein short contact times between carbon and flue gas necessitate an activated carbon material with larger pores to facilitate adsorption of mercury.

Another example application addressed by the embodiments herein is in supercapacitors, which are useful for their very high power densities. In particular, carbon electrodes in supercapacitors require mesoporosity/microporosity structures, also as disclosed herein, to allow rapid charging and discharging, making the presence of an increase in mesoporosity very beneficial, of which the present application provides. Specifically, supercapacitors provides for high energy storage due to its outstanding aspects of a high power density (10³-10⁴ W kg⁻¹), long cycle life (>10⁶ cycles), low maintenance cost, simplicity, and of which is generally safer. The activated carbon materials disclosed herein can be configured as an electrochemical supercapacitor because the beneficial specific surface area, pore structure, etc., of the configured activated carbon electrodes coupled with ionic conductivity and voltage stability of the right electrolyte are the main factors which regulate the energy stored in such devices.

Thus, while microporous activated carbon materials are useful as electrode materials, which deliver high capacitance and power density due to their very high surface area and pore volume, the embodiments herein are also capable of being tailored with a mesopore volume and thus a mesopore/micropore fractional content to also enable desired interconnectivity for electrolytes to effectively reach all the available surface area in the activated carbon architecture. Thus, an appropriate control over mesopore/micropore volume, capable of being provided herein, coupled with a proper choice of an electrolyte, enables the required performance of the configured novel supercapacitors disclosed herein in terms of both power delivery rate and energy storage capacity. A similar benefit addressed herein applies to battery applications which demand rapid charge and discharge rates.

### Yield:

The relatively high char yield of lignin-rich biorefinery residuals is another beneficial aspect of using FRS for the production of activated carbon. The char yield of MBS FRS (relative to initial oven-dried weight of FRS) before activation is found to be consistently higher than 40%, and as high as 43%. Biorefinery processes designed to more efficiently remove the carbohydrate fraction of biomass potentially yields an FRS with even higher char yield.

Increased carbohydrate utilization coupled with higher activated carbon yield represents a synergistic relationship when considering a potential biorefinery incorporating an integrated process for the production of fuels and/or chemicals and activated carbon. For comparison, the char yield of finely milled Douglas fir wood chips heated to 700° C. is found to be less than 20% under identical experimental conditions to those used for production of FRS-based AC. Given that the activation process burns away a significant portion of the carbon, the yield of activated carbon from Douglas fir without pretreatment is in the 10-15% range or even lower depending on the desired porosity of the final product, whereas the yield of activated carbon using MBS-treated FRS from Douglas fir forest residuals is as high as 20-30%, roughly twice that of the yield obtained from untreated Douglas fir.

The chars and activated carbons to show the benefits of the resultant activated carbon materials herein, have been characterized by gas physisorption using a Micromeritics TriStar II Plus 3030 physisorption analyzer equipped with a 1000 Torr transducer. Adsorptives used for porosity characterization are ultra-high purity nitrogen or carbon dioxide. Physisorption experiments are most often run at a temperatures of 77K for nitrogen and 273K for carbon dioxide by immersing the sample tube in either liquid nitrogen or ice water, respectively. For all physisorption experiments, samples are first outgassed on a Micromeritics VacPrep 061 desorption apparatus at room temperature to a pressure of less than 100 mTorr. The samples are then heated to 300° C. and further outgassed for a minimum of 3 hours. During outgassing at 300° C. the pressure reached 25 mTorr. The samples are then cooled under vacuum to room temperature before transferring them to the physisorption analyzer for acquisition of adsorption isotherms.

Nitrogen adsorption isotherms are collected over a partial pressure range (P/P⁰) of 10⁻⁴-0.99 with an equilibration time set at 15 seconds (determined by measuring isotherms at different equilibration times), and only data points above P/P⁰=10⁻³ were used for calculations due to the limits of sensitivity of the pressure transducer. Carbon dioxide adsorption isotherms are measured over a partial pressure range of 10⁻⁵-0.03 with an equilibration time set at 20 seconds.

The apparent Brunauer-Emmett-Teller surface areas (S_{BET}) are determined by applying the BET equation to the nitrogen isotherm data in the partial pressure range of 10⁻³-10⁻¹. The total pore volumes are estimated based on the amount of nitrogen adsorbed at a partial pressure of roughly 0.95. An estimation of the relative pore volume fraction attributable to micropores and mesopores is then obtained by application of nonlocal density functional theory (NLDFT). Micropore volumes from both nitrogen and carbon dioxide adsorption isotherms were also estimated with the Dubinin-Raduschkevich (DR) equation from the linear portion of the data after transforming the isotherm data using the DR equation.

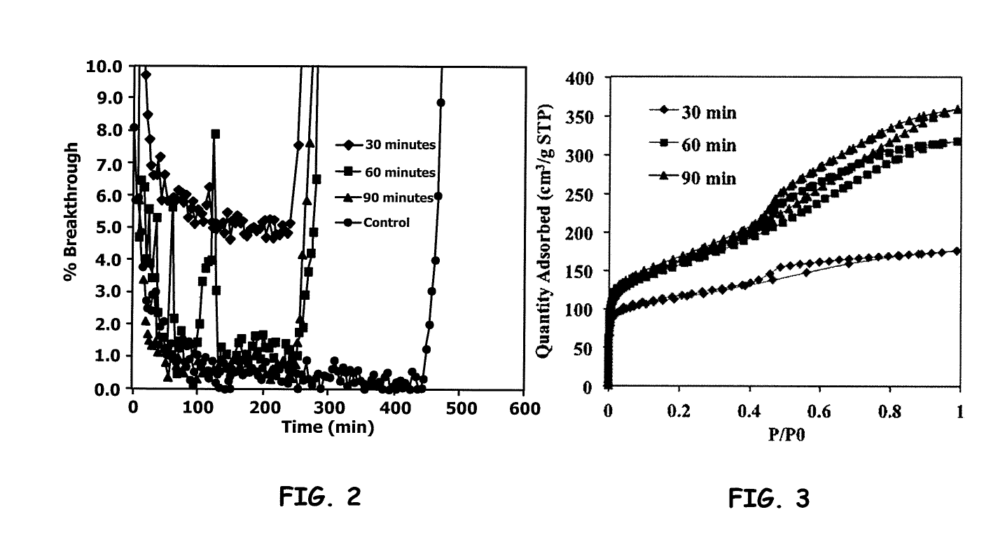

Turning back to the figures, FIG. 2 thus shows a plot of the concentration of elemental mercury in a simulated coal combustion flue gas after passing through a fixed bed of sand containing activated carbon. The concentration of elemental mercury at the outlet of the sorbent bed is expressed as the percentage of the concentration of mercury present in the gas stream before contacting with the AC at the inlet of the sorbent bed. For example, 1% breakthrough corresponds to 99% removal of mercury from the simulated combustion flue gas. These materials were produced by activating SPORL FRS chars for different amounts of time (30, 60, and 90 minutes) in a flow of carbon dioxide at 700° C. The improved ability of the materials activated for 60 and 90 minutes compared to the material activated for 30 minutes is believed to originate from the increase in mesopore volume obtained at longer activation times.

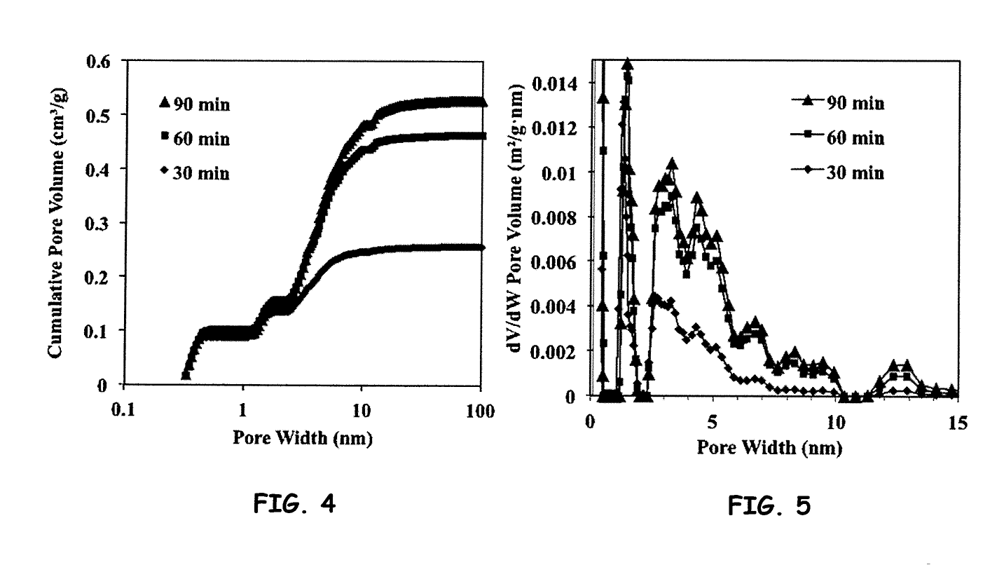

In order to understand the behavior of the materials, it is useful to compare the pore sizes in different AC materials. To measure the development of porosity in the SPORL FRS-based AC materials during physical activation, nitrogen and carbon dioxide adsorption experiments were conducted at 77K and 273K, respectively, using a Micromeritics TriStar II Plus 3030 gas physisorption instrument. The nitrogen adsorption-desorption isotherms are shown in FIG. 3 and corresponding pore size distributions are shown in FIG. 4 and FIG. 5. The cumulative pore volume as a function of the pore width (up to a pore width of 100 nm) was calculated using nonlocal density functional theory (NLDFT) assuming a carbon slit-shaped pore with commercially available MicroActive™ software (Micromeritics Inc.).

FIG. 3 thus shows adsorption isotherms illustrating two important points regarding the effect of activation on the development of porosity in the AC materials:

1) An increase in overall nitrogen adsorption with increasing activation time indicates an increase in the overall volume of pores with sizes up to about 100 nm in entrance width with longer activation time, and
2) The enlargement of hysteresis loops observed in the complete adsorption-desorption cycle indicates the development of mesoporosity with increasing activation time.

FIG. 4 shows the cumulative pore volume as a function of the pore entrance width as calculated with NLDFT. FIG. 3 by contrast shows that the materials activated for 60 and 90 minutes have a significantly higher total pore volume (by roughly a factor of 2) compared to the material activated for 30 minutes, and that this additional pore volume is almost entirely attributed to mesopores, or pores that are larger than 2 nm in size.

FIG. 5 shows the derivative of the data presented in FIG. 4 on a linear scale (vs. the logarithmic scale presented in FIG. 3). FIG. 5 thus allows a closer inspection of the difference between the AC materials prepared at different activation times. From FIG. 5 it can be concluded that most of the increase in pore volume observed when increasing the activation time to 60 and 90 minutes can be attributed to pores in the size range of 2-15 nm in entrance width, with the majority of the mesopores between about 2 and 8 nm in size.

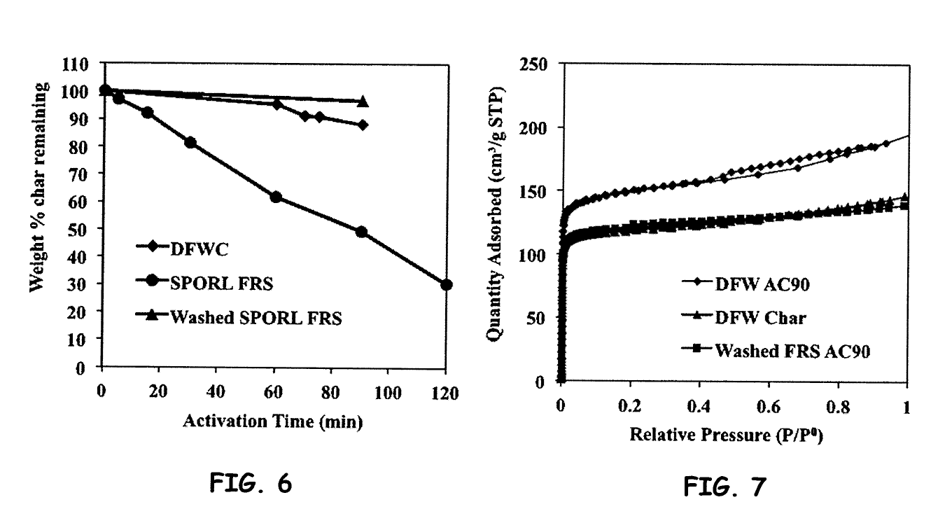

The increase in mesopore volume shown in the previous figures is believed to originate from the catalytic effect of the inorganic species introduced in the material during the SPORL pretreatment, which are mostly calcium salts but can also be sodium or magnesium depending on the cation used for SPORL pretreatment. The presence of inorganic species during physical activation widens the pore size distribution of the resultant AC into the mesopore size range. The increased mesoporosity of these materials increased the capability of the AC to capture mercury from simulated coal combustion flue gas, as shown in FIG. 2 and is expected to have benefits in other adsorption applications requiring wider pores to enable faster diffusion of adsorptive species to micropores or adsorption of larger molecules too large to access microporosity. The inorganics also allow the materials to be activated at lower temperature compared to wood or demineralized FRS. This point is demonstrated in FIG. 6, as discussed below.

FIG. 6 shows the amount of char remaining as a percentage of initial char weight as a function of the activation time at 700° C. under a flow of carbon dioxide. After roughly 90 minutes of activation, a burn-off of about 12% by weight was observed for Douglas Fir wood char (DFWC). SPORL FRS char burned off much faster compared to DFWC, reaching a burn-off of around 50% after 90 minutes under identical activation conditions. When the inorganics were removed from SPORL FRS by washing it with 10% HCl prior to carbonization (demineralization), the char reactivity toward physical activation was considerably lower (based on the yield after 90 minutes of activation at 700° C.). These results show that the relative reactivity of the SPORL FRS chars toward gasification by CO₂ was considerably higher compared to chars prepared under identical conditions using either Douglas Fir wood powder or demineralized FRS as the char precursor. Based on these results we conclude that the presence of the inorganic species introduced during SPORL pretreatment provide a catalytic effect for the gasification reactions occurring between the char and carbon dioxide during activation. According to the available literature on activated carbon production, physical activations are normally conducted in the range of 800-1000° C. for the production of activated carbons from different precursors and often use steam or steam/CO₂ mixtures, since the gasification reaction of water with solid carbon is less endothermic than the reaction between CO₂ and carbon (known as the Boudouard reaction). A novel aspect of the process to utilize SPORL FRS as activated carbon precursor is that the SPORL pretreatment allows the physical activation reaction to be conducted under lower temperature with CO₂ without the use of steam, reducing the overall energy consumption of the process and enabling better control over the porosity development.

The effect of the presence of the inorganic species on the development of mesoporosity can also be seen from the analysis of the adsorption isotherms of activated carbons prepared from Douglas fir wood char (DFWC) and demineralized FRS. The adsorption isotherms and corresponding pore size distributions are shown in FIG. 7-9.

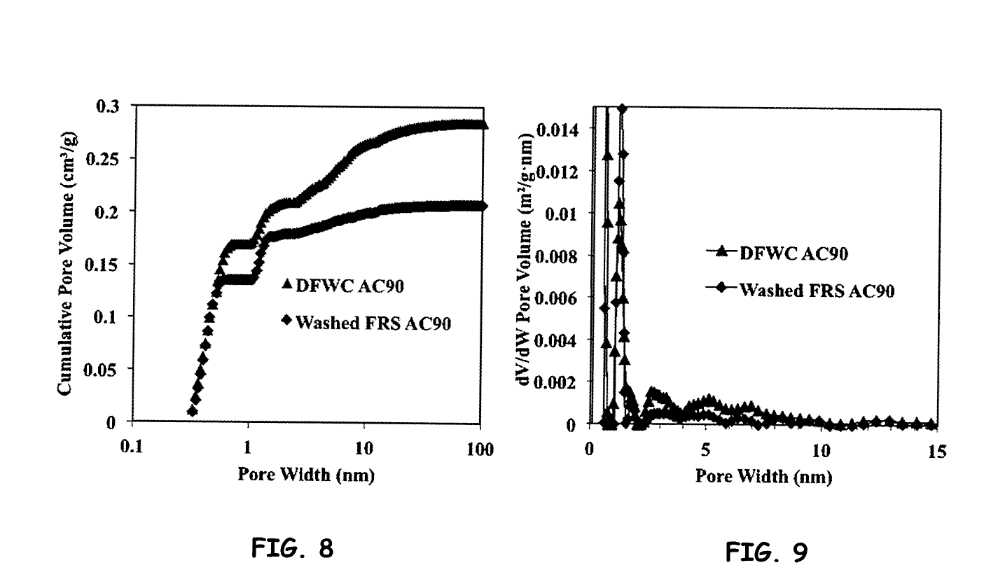

In contrast to the adsorption isotherms shown for SPORL FRS-based AC in FIG. 3, the shape of the isotherms in FIG. 7 are largely Type I with only slight desorption hysteresis observed for DFW AC90 and no hysteresis observed for the Douglas Fir char or the demineralized FRS char after 90 minutes of activation at 700° C. FIG. 7 clearly illustrates that these materials are mainly microporous with little or no mesoporosity. This point is further illustrated by calculation of the pore size distribution with NLDFT, as shown in FIG. 8 and FIG. 9. The lack of mesoporosity in wood-based and demineralized FRS-based AC suggests that the inorganic species present in the SPORL FRS strongly affect the development of mesoporosity as well as total pore volume through their catalytic effect on the process of physical activation. SPORL pretreatment of softwood biomass followed by saccharification and fermentation is therefore believed to provide a unique and advantageous platform for the production of mesoporous activated carbon through physical activation.

The following resultant characteristics of the activated carbon structures disclosed in the present application are intended to be illustrative in nature and are not to be considered as limiting the scope of the systems and methods disclosed herein.

In particular, the obtained example activated carbons had the following range of characteristics depending on the type of pretreatment used to prepare the FRS and the activation time.

### Apparent BET Specific Surface Area (S_{BET}):

Carbons prepared from Mild Bisulfite Fermentation/hydrolysis Residual Solids:
S_{BET} Greater than 500 m²/g, up to 650 m²/g for unwashed physically activated materials and up to 800 m²/g for materials washed with aqueous hydrochloric acid, pH ˜1.

Note: for chemically activated materials (e.g. using potassium hydroxide as activating agent and preparing at 800° C. followed by washing with water) S_{BET} is greater than 500 m²/g and can approach very high values around 2500 m²/g.

Carbons prepared from Wet Oxidation Fermentation Residual Solids:
S_{BET} greater than 500 m²/g, up to 1200 m²/g for physically activated materials.

### Total Pore Volume (V_{p,tot})

Note: (assessed from nitrogen adsorption isotherms measured at 77K by Gurvitsch Rule, where Total amount of N₂ adsorbed at P/P⁰˜0.95 is multiplied by density conversion factor for N₂)

Carbons prepared from Mild Bisulfite Fermentation/hydrolysis Residual Solids:
V_{p,tot} greater than 0.25 cm³/g up to 0.8 cm³/g for physically activated materials. Note: maximum value is obtained using washed carbons (washed with aqueous hydrochloric acid, pH 1). Unwashed carbon can reach a value of 0.7 cm³/g.

For chemically activated materials, V_{p,tot} can reach up to about 1 cm³/g.

Carbons prepared from Wet Oxidation fermentation/hydrolysis Residual Solids:
V_{p,tot} greater than 0.25 cm³/g up to 0.62 cm³/g for physically activated materials.

### Micropore Volume V_{DR,N2})

Note: (assessed using the Dubinin-Raduschkevich equation using nitrogen adsorption isotherms measured at 77K):

Carbons prepared from Mild Bisulfite Fermentation/hydrolysis Residual Solids:
V_{DR,N2} greater than 0.15 cm³/g up to 0.32 cm³/g for washed (HCl pH 2) carbon. Unwashed carbon can reach micropore volume of 0.25 cm³/g.

Carbons prepared from Wet Oxidation fermentation/hydrolysis Residual Solids:
V_{DR,N2} greater than 0.15 cm³/g up to 0.5 cm³/g.

### Micropore Volume

Note: (pores smaller than 1 nm in entrance dimension) V_{DR,CO2} (assessed using the Dubinin-Raduschkevich equation using carbon dioxide adsorption isotherms measured at 273K):

Carbons prepared from Mild Bisulfite Fermentation/hydrolysis Residual Solids:
V_{DR,CO2} greater than 0.15 cm³/g up to 0.25 cm³/g (unwashed), and up to 0.32 cm³/g for washed materials.

Carbons prepared from Wet Oxidation fermentation/hydrolysis Residual Solids:
V_{DR,CO2} greater than 0.15 cm³/g up to 0.31 cm³/g.

### Relative Fraction of Mesopores and Micropores by NLDFT

Note: (volume of mesopores=Vₘₑₛₒ, volume of micropores=V_{micro})

Carbons prepared from Mild Bisulfite Fermentation/hydrolysis Residual Solids:
Vₘₑₛₒ/(Vₘₑₛₒ+V_{micro})=0.2−0.8

Carbons prepared from Wet Oxidation fermentation/hydrolysis Residual Solids:
Vₘₑₛₒ/(Vₘₑₛₒ+V_{micro})=0.2−0.3

It is also to be noted that mesopore volumes of 0.05-0.50 cm³/g for the carbons have been produced by physical activation of the mild bisulfite fermentation residual solids. By comparison, the highest mesopore volume estimated in using the wet oxidation-based materials is about 0.2 cm³/g.

It is to be understood that features described with regard to the various embodiments herein may be mixed and matched in any combination without departing from the spirit and scope of the invention. Although different selected embodiments have been illustrated and described in detail, it is to be appreciated that they are exemplary, and that a variety of substitutions and alterations are possible without departing from the spirit and scope of the present invention.

We claim:

1. A method of producing high grade activated carbon, comprising:
providing soft woody biomass material;
pretreating the soft wood biomass material, wherein the pretreated soft wood biomass material results in a mass of fermentation residual solids having a desired content of lignin;
pyrolysing/carbonizing the fermentation residual solids in an inert environment at a temperature rate of 10° C./min up to about 700° C. and held at the upper temperature range for up to one hour to produce a char;
activating the char by changing the inert environment after one hour at 700° C. to an oxidizing environment at a desired oxidizing gas flow rate for a time period of about 5 minutes up to about 120 minutes;
switching back to an inert environment and allowing the environment to cool until room temperature is reached; and
removing the produced activated high grade activated carbon.

2. The method of claim 1, wherein the method includes providing for a high grade activated carbon configured with mesopore volumes of 0.05 up to 0.50 cm³/g.

3. The method of claim 1, wherein the method includes providing for a high grade activated carbon configured with a pore volume fraction (Vₘₑₛₒ/(Vₘₑₛₒ+V_{micro}) ranging from 0.2 up to 0.8.

4. The method of claim 1, wherein the method includes providing for a high grade activated carbon configured with an apparent specific area ranging from 500 m²/g up to 2500 m²/g.

5. The method of claim 1, wherein the method includes providing for fermentation residual solids comprising about 50% up to about 70% lignin.

6. The method of claim 1, wherein the activating step includes at least one activating method selected from: physical and chemical activation.

7. The method of claim 1, wherein the high grade activated carbon is utilized for adsorbing mercury.

8. The method of claim 1, wherein the high grade activated carbon is configured as carbon electrodes in supercapacitor.

9. The method of claim 1, wherein the pretreatment method is a method selected from: a Wet Ox pretreatment, a Sulfite Pretreatment to Overcome Recalcitrance of Lignocellulose (SPORL), a Tandem Milling pretreatment, and a Mild Bisulfite (MBS) pretreatment.

10. The method of claim 9, wherein the pretreatment method results in a char yield of up to about 43%.

11. An activated carbon composition suitable for use as an adsorbent or electrode, the composition comprised of: a configuration having mesopore volumes in the range of 0.05 up to 0.50 cm³/g, a pore volume fraction (Vₘₑₛₒ/(Vₘₑₛₒ+V_{micro}) ranging from 0.2 up to 0.8, and an apparent specific area ranging from 500 m²/g up to 2500 m²/g, the composite resulting from activation of lignin-rich fermentation residual solids.

12. The activated carbon composition of claim 11, wherein the activated carbon electrode is configured as a mercury adsorbent.

13. The activated carbon composition of claim 11, wherein the activated carbon composition is configured as a supercapacitor carbon electrode.
